(19) United States
(12) Patent Application Publication
(10) Pub. No.: US 2006/0264089 A1
(43) Pub. Date: Nov. 23, 2006

(54) Hot attach & detach application cartridge internally and externally connectable to computer host

(76) Inventor: San-Hai Lin, Si Jhih City (TW)

Correspondence Address: SCHMEISER, OLSEN & WATTS, 22 CENTURY HILL DRIVE, SUITE 302, LATHAM, NY, 12110, US

(21) Appl. No.: 11/269,438

(22) Filed: Nov. 8, 2005

(30) Foreign Application Priority Data
May 19, 2005 (TW) 094208167

(51) Int. Cl. H01R 13/64

(52) U.S. Cl. 439/378

(57) ABSTRACT

A hot attach & detach application cartridge includes an adapter module fixedly mounted in a bay on a computer host to electrically connect to a main board in the computer host, and an application cartridge adapted to receive a corresponding peripheral apparatus therein and to insert into a bay on the computer host having the adapter module mounted therein. The adapter module is provided at a predetermined position with a hot attach & detach SATA male connector; and the application cartridge is provided with a hot attach & detach SATA female connector corresponding to the SATA male connector on the adapter module, and a hot attach & detach USB female connector. Thus, the application cartridge may be internally or externally hot attached to or detached from the computer host via the SATA connector or the USB connector.

### FIELD OF THE INVENTION

The present invention relates to a hot attach & detach application cartridge, and more particularly to a hot attach & detach application cartridge that may be externally connected to a computer host via a cable and USB connectors, or inserted into a bay on the computer host to internally connected to the computer host via an adapter module and SATA connectors.

### BACKGROUND OF THE INVENTION

In response to the prosperous developments in the information industrial fields and the wide application of computers in recent years, various kinds of peripherals have been developed and introduced into the market. Particularly, the electronic industry has quickly entered the multimedia era, and a huge amount of audio-visual data is accessed at high speed. To enable users to conveniently use many portable peripherals, such as removable hard drive, CD-ROM, CD-RW, DVD-ROM, these peripherals are provided with USB interface to be “plug and play”.

Please refer to FIG. 1. Most of the currently commercially available desktop or notebook computers include a computer host 1 having one or more USB connectors 11 provided on a front panel of the computer host 1, so that a peripheral 12 may be connected to the computer host 1 via a USB flat cable 13. A SATA connector is another type of hot attach & detach connector that provides even faster transmission speed than the USB connector, and is typically used on computers and servers of new generation. Since the super-high transmission speed of SATA is restricted by the length of the connecting flat cable thereof, it is not advisable to use a long flat cable when a high-speed transmission is desired. This is why most computer manufacturers do not provide sockets for SATA connectors on the front panel of the computer host.

Moreover, peripherals with hot attach & detach SATA connectors usually have sizes only suitable for use in bays on an initial corresponding computer host but not bays on other computers. It is therefore apparently difficult to externally connect a peripheral to a computer host via the SATA connector.

It is therefore tried by the inventor to develop a hot attach & detach application cartridge that may be externally connected to a computer host via a cable and USB connectors, or inserted into a bay on the computer host to internally connect to the computer host via an adapter module and SATA connectors.

### SUMMARY OF THE INVENTION

A primary object of the present invention is to provide a hot attach & detach application cartridge that may be externally connected to a computer host via a cable and USB connectors, or inserted into a bay on the computer host to internally connect to the computer host via an adapter module and SATA connectors.

To achieve the above and other objects, the hot attach & detach application cartridge externally and internally connectable to computer host according to the present invention includes an adapter module located in a bay on the computer host to electrically connect to a main board in the computer host, and an application cartridge adapted to receive a corresponding peripheral apparatus therein and to insert into a bay on the computer host having the adapter module mounted therein.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 shows an example of conventional hot attach & detach arrangement;

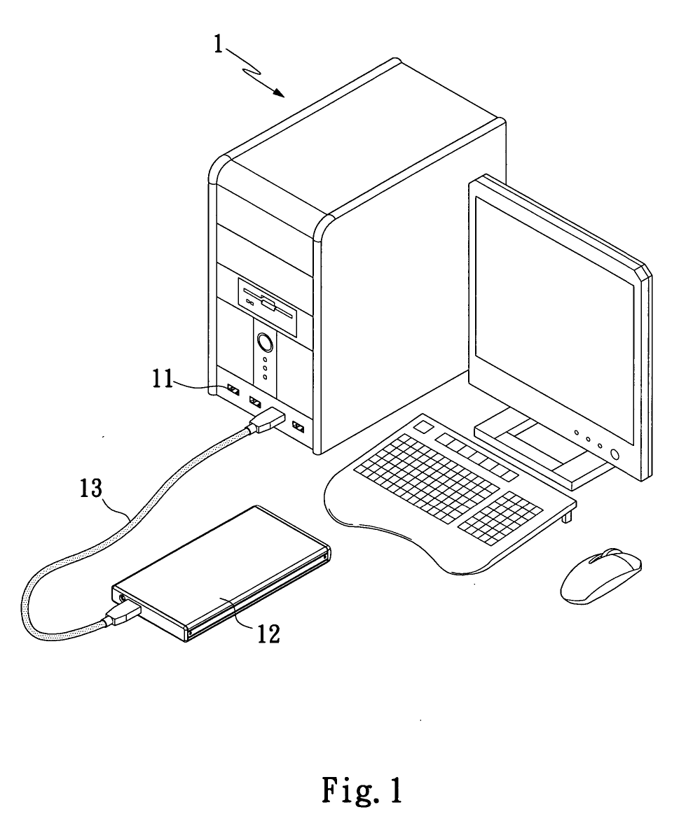

FIG. 2 is an exploded perspective view of the present invention;

FIG. 3 shows a first manner of using the present invention; and

FIG. 4 shows a second manner of using the present invention.

### DETAILED DESCRIPTION OF THE PREFERRED EMBODIMENTS

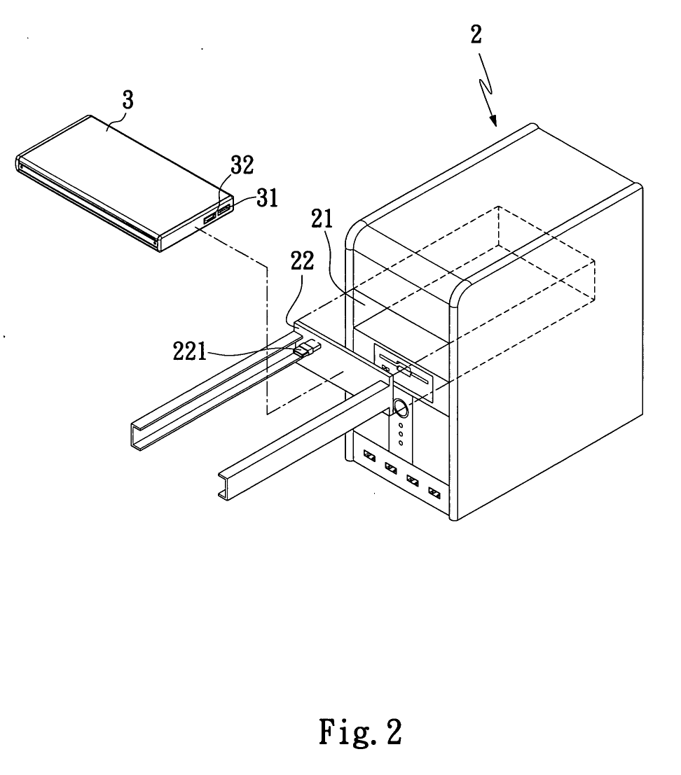

Please refer to FIG. 2 that is an exploded perspective view of a hot attach & detach application cartridge externally and internally connectable to computer host according to the present invention. As shown, the hot attach & detach application cartridge of the present invention includes an adapter module 22 fixedly mounted in a bay 21 on a computer host 2 to electrically connect to a main board in the computer host 2, and an application cartridge 3 adapted to receive a corresponding peripheral apparatus therein and to insert into the bay 21 on the computer host 2 having the adapter module 22 mounted therein.

The adapter module 22 is provided at a predetermined position with a SATA male connector 221. The application cartridge 3 is provided at a first position with a SATA female connector 31 corresponding to the SATA male connector 221 on the adapter module 22, and at a second position with a USB female connector 32.

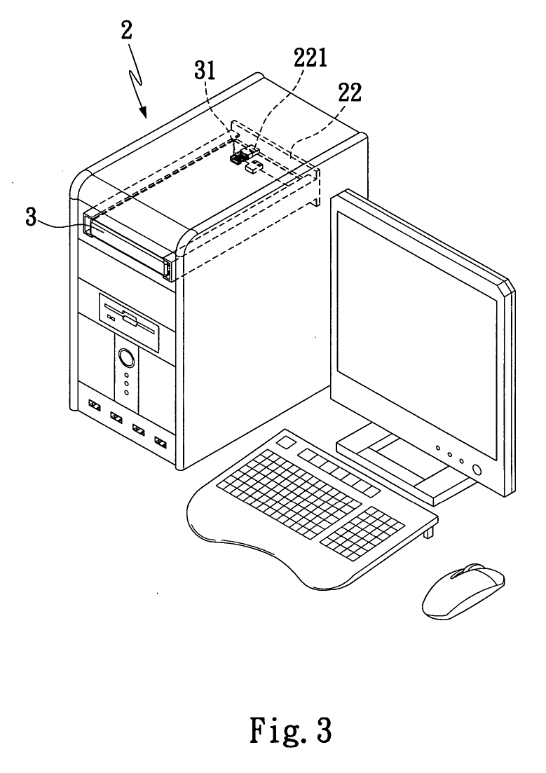

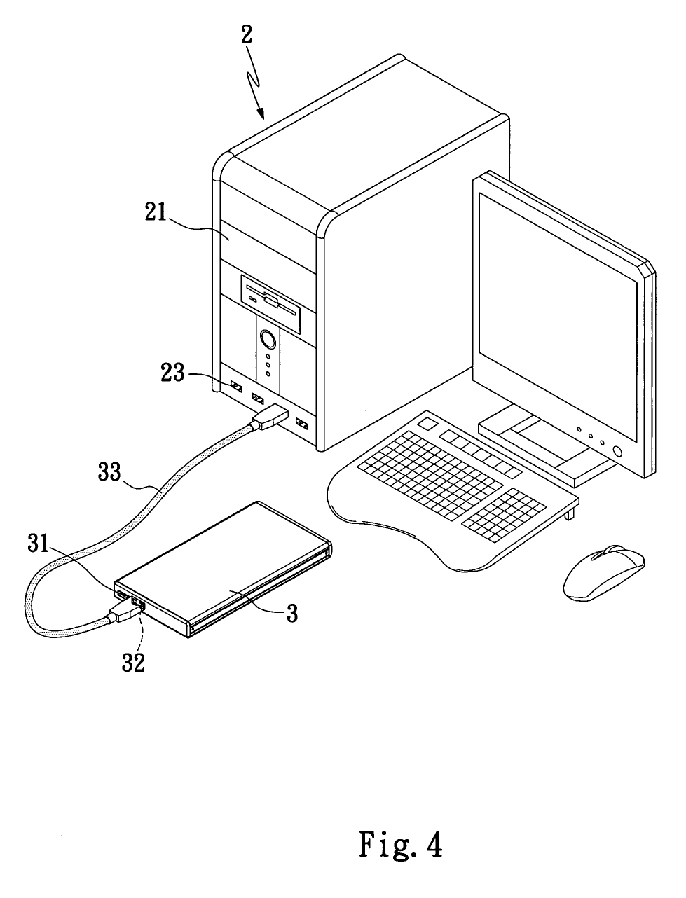

In FIG. 3, the application cartridge 3 is inserted into the bay 21 on the computer host 2 to contact with the adapter module 22 in the bay 21. And, in FIG. 4, the application cartridge 3 is externally connected to the computer host 2 via a USB flat cable 33.

More specifically, the adapter module 22 is fixedly mounted in the bay 21 on the computer host 2, and is connected at the SATA male connector 221 to a main board (not shown) in the computer host 2 via a flat cable (not shown). When the application cartridge 3 is inserted into the bay 21, the SATA female connector 31 on the application cartridge 3 is directly engaged with the SATA male connector 221 on the adapter module 22, as shown in FIG. 3.

In the event the computer host 2 does not internally include a SATA male connector 221, the application cartridge 3 may be otherwise connected to the computer host 2 via a USB flat cable 33, which has a first end plugged into the USB female connector 32 on the application cartridge 3 and a second end plugged into a USB connector 23 provided on a front panel of the computer host 2, as shown in FIG. 4.

With the above arrangements, the application cartridge 3 may be externally connected to the computer host 2 via the USB flat cable 33, or inserted into the bay 21 on the computer host 2 to connect to the SATA male connector 221 on the adapter module 22 in the bay 21. In brief, the application cartridge 3 allows a user to select either to internally or externally hot attach or detach the application cartridge 3 to or from the computer host 2.

What is claimed is:

1. A hot attach & detach application cartridge internally and externally connectable to computer host, comprising an adapter module fixedly mounted in a bay on a computer host to electrically connect to a main board in said computer host, and an application cartridge adapted to receive a corresponding peripheral apparatus therein and to insert into a bay on said computer host having said adapter module mounted therein; said adapter module being provided at a predetermined position with a hot attach & detach SATA male connector; and said application cartridge being provided at a first position with a hot attach & detach SATA female connector corresponding to said SATA male connector on said adapter module, and at a second position with a hot attach & detach USB female connector.
